(19) United States
(12) Patent Application Publication
(10) Pub. No.: US 2021/0133756 A1
(43) Pub. Date: May 6, 2021

(54) EXTENDED PAYMENT INSTRUMENT

(71) Applicant: Bank of America Corporation, Charlotte, NC (US)

(72) Inventor: Katherine Dintenfass, Lincoln, RI (US)

(21) Appl. No.: 16/668,881

(22) Filed: Oct. 30, 2019

(51) Int. Cl. G06Q 20/40; G06Q 20/38; G06Q 20/20

(52) U.S. Cl. CPC G06Q 20/40145; G06Q 20/20; G06Q 20/405; G06Q 20/3821

(57) ABSTRACT

Apparatus and methods are provided for a donor to extend funds and/or a line-of-credit from a personal account to a donee. The donor may provide donor credentials to the donee. The donor credentials may be added to a payment instrument of the donee. Adding the donor credentials to the donee payment instrument may “extend” the donee payment instrument. The donor may impose restrictions on using the donor credentials. For example, the donee may only use the donor credentials at specific places and for purchases within category limits. In some embodiments, when a donee exceeds a limit associated with donor credentials, an alert is sent to the donor. The alert notifies the donor and requests authorization for the donee to continue using the donor credentials.

### FIELD OF TECHNOLOGY

Aspects of the disclosure relate to a donee payment instrument that extends the donee payment instrument by adding donor credentials to the donee payment instrument.

### BACKGROUND

Mobile devices, such as smartphones are now ubiquitous tools. Mobile devices are used for a variety of purposes, including social and work tasks. For example, socially, mobile devices are used for communication among friends. Friends that live geographically apart and would not be able to regularly speak or see each other. Using their mobile device, friends may now be in regular contact with each other.

Friends may form virtual groups where they communicate and update each other on life events. Using their mobile devices, friends can easily share career accomplishments, life challenges, or appeal to their close circle of acquaintances for advice or assistance.

Because friends may now be in regular contact with each other, an appeal for help by one friend may be viewed with creditability by other members of a virtual group. In response to the appeal for help, members of a virtual group may take action to provide the requested assistance. For example, based on prior or ongoing communications, friends may be aware that a member of their virtual group needs financial assistance. A request for help may be supported by shared communications that reflect lifestyle changes or provide contextual clues. Exemplary lifestyle changes may include moving to reduce housing costs or looking for a new job. Contextual clues may include comments or posted pictures that indicate a change in spending habits or use of charitable services.

Friends may be aware of each other's struggles and motivated to lend assistance because a request for help with those struggles may be associated with observable communications and contextual clues. Mobile devices also make it easier for information to be shared with people outside the close circle of friends or others not a member of a virtual group. So, although friends may wish to help a friend in need, a friend in need may be reluctant to ask or accept help because of a possibility that their needs or situation may be publicized outside a trusted circle of friends.

Outside the context of social networking, friends may become of aware that an acquaintance needs financial assistance by talking to the acquaintance or through speaking with other mutual friends. The friends may wish to help, efficiently and respectfully.

It would be desirable to provide a system and apparatus that allows friends to help each other by enhancing functionality of payment instruments already in use by a friend-in-need (hereinafter, “donee”). It would be desirable to provide a system and apparatus that allows donors to help a donee in a manner that maintains the dignity of the donee. Maintaining the dignity of a donee may include providing a donee access to donated funds in seamless manner and in a way that is indiscernible to an outside observer.

Accordingly, it would be desirable to provide an EXTENDED PAYMENT INSTRUMENT.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative apparatus and scenario in accordance with principles of the disclosure;

FIG. 2 shows an illustrative apparatus and scenario in accordance with principles of the disclosure;

FIG. 3 shows an illustrative apparatus and scenario in accordance with principles of the disclosure;

FIG. 4 shows an illustrative apparatus and scenario in accordance with principles of the disclosure;

FIG. 5 shows an illustrative apparatus and scenario in accordance with principles of the disclosure;

FIG. 6 shows an illustrative apparatus and scenario in accordance with principles of the disclosure;

FIG. 7 shows an illustrative process in accordance with principles of the disclosure;

FIG. 8 shows an illustrative apparatus and scenario in accordance with principles of the disclosure;

FIG. 9 shows illustrative apparatus in accordance with principles of the disclosure; and

FIG. 10 shows illustrative apparatus in accordance with principles of the disclosure.

### DETAILED DESCRIPTION

Apparatus for a payment instrument is provided. The payment instruments may store data in a magnetic strip, a bar code, a silicon chip, non-volatile computer readable media or any other suitable data storage device or format. Illustrative payment instruments may include a credit card, debit card, a check, a device that includes a contactless chip (such as an ISO14443-compliant contactless chip), a smart phone, a tablet computer, a transponder or any other suitable electronic purchasing devices.

A payment instrument may be associated with a digital wallet application. A digital wallet application may run on a mobile device and communicate with a merchant point-of-sale (“POS”) terminal. The digital wallet application may transfer a token or other information associated with a payment instrument to the POS terminal. Based on the information received from the digital wallet application, the POS terminal may attempt to process a purchase transaction. A purchase transaction may include drawing on a line-of-credit or transfer funds to the merchant in exchange for a desired goods or services. A payment instrument may store information provided by the digital wallet to the POS terminal.

A customer (alternatively, “user” or “donee”) may purchase goods or services (hereinafter, “product”) from a merchant by presenting a payment instrument (or information associated with a payment instrument via a digital wallet application) at a POS terminal. The purchase may be conducted through any suitable channel of commerce. The payment instrument may allow the customer to draw on a line-of-credit or transfer funds to the merchant in exchange for the desired product. The payment instrument may provide the customer/merchant access to funds or credit controlled by an issuing bank (the “issuer”) associated with the payment instrument.

For example, customer funds may be held in an account at the issuing bank. Activities associated with the account may be administered by the issuer bank. Illustrative activities may include withdrawals, deposits, transfers and record keeping. Using the payment instrument, the customer may trigger an activity. For example, the customer may initiate a request to transfer funds to a merchant and debit the account.

The merchant, at a POS terminal, may receive the request. The merchant may submit the request to an acquiring bank (the “acquirer”). The acquirer may request that the issuing bank provide an authorization decision (e.g., “granted” or “denied”) for the request. The issuer may be provided an opportunity to provide an authorization decision for the purchase before extending credit on behalf of the customer or before acquiescing to the request to debit the customer account.

Typically, by granting authorization for the transaction, the issuer accepts responsibility for subsequent costs associated with the purchase. Subsequent costs may be associated with settling the transaction, providing funds to the merchant, responding to allegations of fraud, chargebacks, or other events that arise after an authorization decision granting the purchase has been provided. An issuer may decline to accept responsibility for a transaction by denying authorization for the purchase in response to an authorization decision request.

The acquirer may request an authorization decision from the issuer by submitting a transaction record to the issuer via a transaction processing network. The transaction record may include items being purchase, amount of the purchase, location of the purchase, identity of the merchant, customer information and payment instrument information. A transaction processing network may link acquirers, issuers and other transaction participants such as donors that are willing to help the customer.

A transaction processing network may receive an authorization decision from an issuer and transmit the authorization decision to the acquirer. In response to receiving a granted authorization decision, the merchant may release the desired product to the customer. In response to receiving a denial authorization decision, the merchant may prompt the customer to provide an alternative payment method (e.g., cash).

When a “granted” authorization decision is provided by the issuer, the acquirer pays the merchant for (and thus “acquires”) the purchase. The transaction processing network (in communication with the issuer and the acquirer) may settle transactions between the issuer and the acquirer. A transaction settlement process may include a transfer of funds between two or more transaction participants. The transfer may be a “book transfer,” an inter-bank transfer or any suitable transfer between the transaction participants. A settlement network may transfer the funds between transaction participants. Illustrative settlement networks may include the Federal Reserve Wire Network (“Fedwire”) and other suitable settlement networks that are well known to those of ordinary skill in the art. The settlement network may include any suitable network linking one or more accounts of transaction participants.

Donors may donate funds/credit to donee. A donor may extend a line-of-credit to a donee. The line-of-credit may be associated with restrictions. The restrictions may be defined by the donor. Illustrative restrictions may include limiting use of the line-of-credit to specific locations and/or for specific categories of products/services. The restrictions may be defined based on analysis of one or more data sets associated with the donee. The analysis may be generated by artificial intelligence. For example, the artificial intelligence may identify location and products typically used by the donee and may limit use of donated funds/credit to purchases at the typical location and for the typical products.

A payment instrument may be presented to a merchant by the customer to purchase a product. A merchant POS terminal may receive data from, provide data to, or exchange data with the presented payment instrument. The presented payment instrument may be a physical payment instrument, or a virtual payment instrument associated with a mobile wallet application.

In some embodiments, a payment instrument may include a housing. The housing may be plastic, metal or any other suitable material. Illustrative dimensions of the housing may be 85.60 millimeters (“mm”)×53.98 mm×0.8 mm. The payment instrument may include a microchip. The microchip may include one or more integrated circuits. The microchip may include an integrated circuit that provides the functionality of a microprocessor. The microchip may store account information. The microchip may be embedded in the housing. For example, the microchip may have a thickness that is not greater than 0.25 mm.

In digital wallet embodiments, the microchip may be part of a mobile device running a digital wallet application. The microchip may store an executable payment processing application. The microchip may execute the payment processing application. A POS terminal may access the payment processing application stored on the microchip. The POS terminal may execute the payment processing application using hardware of the POS terminal. A microchip may store two or more payment processing applications.

A payment processing application may provide rules for formulating a request to transfer funds to a merchant and debit an account and complete a purchase or other transaction. The payment processing application, when executed, may generate a unique code that is only valid for the instant transaction. The unique code may be transmitted to the issuer for consideration as part of an authorization decision.

The POS terminal may interact with the microchip via contact or contactless communication. When using contact communication, the microchip may physically touch a chip reader or other component of a POS terminal. A payment instrument may include a wireless communication circuit for contactless communication. The wireless communication circuit may transmit information stored on the microchip to the POS terminal and receive information from the POS terminal.

When a payment instrument is inserted into a POS terminal, the POS terminal may provide power and activate the microchip and/or a wireless communication circuit. For example, the POS terminal may supply electricity that powers the microchip. The POS terminal may generate high frequency signals. The wireless circuit and microchip may be powered by the high frequency signals. A payment instrument may be configured to utilize high frequency signals to recharge a battery. High frequency signals may be signals that have a transmission range that is less than 50 centimeters (“cm”).

A payment processing application stored on the microchip may be executed to verify an identity of the customer, an authenticity of the microchip itself and/or account information stored on the microchip. For example, to verify the customer's identity, the POS terminal may prompt the customer to enter a code at a POS terminal. The code may be a personal-identification-number (“PIN”).

Entry of a PIN may identify the customer and may trigger execution of a second payment processing application. The POS terminal may verify an entered PIN by comparing a PIN entered by the customer to a data element stored on the microchip. The PIN may be encrypted before comparing to the data element stored on the microchip. The POS terminal may verify a PIN by transmitting the PIN to a remote server for verification. The PIN may be encrypted before transmitting the PIN to the remote server.

In some embodiments, a donor may initiate a transfer of funds directly into an account of a donee. The account may be a personal account of the donee. The account may be a specially created account. The specially created account may administered by a third party, such as an issuer bank. The donor and donee may have access to the specially created account. The donee may utilize a payment instrument to access the donated funds. The payment instrument may include a payment processing application that is configured to access the specially created account and/or funds transferred by a donor into the donee's personal account.

In some embodiments, a personal account of the donor may be linked to a personal account of the donee. For example, the donee may use a payment instrument linked to the donee's account to initiate a purchase. The donee's account may be linked to the donor's account. When an authorization request is received by an issuer to debit the donee's account, the issuer may determine whether to grant the authorization request based on funds available in the donor's account.

In some embodiments, a payment processing application stored on the donee's payment instrument may link a donee account to a donor account. The payment processing application may provide information associated with the donor account to a POS terminal. The POS terminal may be configured to implement any restrictions associated with using the donor account. The payment processing application may provide instructions to the POS terminal for ensuring compliance with the restrictions.

The POS terminal may generate and transmit an authorization request that includes the donor account information. The POS terminal may submit the authorization request to a bank of the donor. The POS terminal may submit the authorization request to an issuer associated with the donee payment instrument. The computer system of the donee's issuer may generate and submit an authorization request to a bank or issuer associated with the donor.

A payment processing application may link a payment instrument to a set of credentials. A set of credentials may include information required to initiate account activity. A set of credentials may provide access to funds and/or a line-of-credit. Illustrative activity may include authenticate a request for the activity, authorize a request to debit an account or draw down a line-of-credit. Credentials may include a unique number assigned to the payment instrument, a name of a customer associated with the payment instrument, an expiration date of the payment instrument, an issuer associated with the payment instrument and any other suitable information.

Credentials may be donor credentials. Donor credentials may include donor account information. The donor account may be a personal account of the donor. The donor may authorize use funds in the personal account of the donor to pay for purchases made by a donee. The donor may authorize extending credit to a donee based on funds in the personal account of the donor. Donor credentials may include a line-of-credit available to the donor. The donor may authorize extending credit to a donee by drawing down the donor's line-of-credit.

Donor credentials may include a specially created account. The specially created account may hold funds or credit donated by one or more donors. The one or more donors may authorize use of funds in the special account to pay for, or extend credit for, purchases made by a donee.

Donor credentials may be linked to a payment instrument. The payment instrument may be a donee's payment instrument. The donee's payment instrument may be associated with donee credentials. Donee credentials may include personal accounts of the donee. Donee credentials may include a line-of-credit available to the donee. The donee credentials may be stored in a microchip on the payment instrument.

The donee credentials may be linked to donor credentials. A microchip of the donee payment instrument may be updated to include linked donor credentials. The microchip on the donee payment instrument may be configured to submit the donor credentials to a POS terminal to initiate a request for account activity. In some embodiments, the microchip may be configured to submit donee and donor credentials to the POS terminal. Donee credentials may be use for a first portion of a purchase (e.g., selected items or amounts). Donor credentials may be use for a second portion of a purchase (e.g., selected items or amounts).

Methods for using a payment instrument issued to a donee to process a transaction based on donor credentials are provided. Methods may include receiving authorization from a donor to link donor credentials to a payment instrument of the donee. The donor may provide authorization in response to a request for assistance received from the donee. The donor may provide authorization in response to perceiving that the donee needs assistance.

The donor may provide authorization to an issuer of the donee payment instrument for the donee to use donor credentials. For example, the donor may use an online banking portal of the issuer to provide the authorization. The donor may associate the authorization with restrictions. An illustrative restriction may include limiting a dollar amount of donee purchases that may utilize donor credentials. An illustrative restriction may include limiting use of donor credentials to specific products or specific locations. Locations may be defined based on geographic location or a merchant category code (“MCC”) associated with a merchant location.

Methods may include detecting use of the donee payment instrument at a POS terminal to initiate a first transaction. The donee payment instrument may include a default payment processing application. The default payment processing application may be configured to execute transactions using donee credentials. In some embodiments, credentials may be stored on a payment instrument. In some embodiments, a payment instrument may include a token that links the payment instrument to a set of credentials.

Methods may include instructing the POS terminal to reconfigure the payment instrument. The reconfiguring may include dynamically reprogramming the payment instrument. The reconfiguring may include configuring the POS terminal to perform the reprogramming. Reconfiguring the payment instrument may include linking donor credentials to the donee credentials.

Donor credentials may be linked to the donee credentials by an issuer computer system. The issuer computer system may link the donor credentials to the donee credentials such that each time a qualifying transaction is initiated using the donee payment instrument, the issuer computer system performs an authorization decision process based on the linked donor credentials. An authorization decision process may be triggered by signal from a POS terminal.

Reconfiguring the payment instrument may include storing linked donor credentials or a token corresponding to the linked donor credentials, on the donee payment instrument. Reconfiguring the payment instrument may include removing linked donor credentials from the donee payment instrument. Reconfiguring the payment instrument may include severing a link between the donee payment instrument and donor credentials.

After reconfiguring the payment instrument, methods may include using the donee payment instrument to initiate a second transaction. The second transaction may be initiated using the donee credentials. The second transaction may be initiated using the linked donor credentials. In some embodiments, even when donor credentials are linked to the donee credentials, only the donee credentials may be stored on the payment instrument. In some embodiments, linked donor credentials may be stored on the donee payment instrument.

Donee or donor credentials may be stored on the payment instrument as a token. A microchip on the payment instrument may store a series of randomly generated numbers (e.g., a “token”) that correspond to a set of credentials. The token may be transmitted to a merchant POS terminal by a payment processing application stored on the microchip. The POS terminal may forward the token to an issuer computer system associated with the payment instrument. The issuer computer system may hold a key for deciphering the token and correlating the token to a specific (e.g., donor) account.

In response to receiving donee credentials linked to donor credentials, methods may include processing the second transaction using the donor credentials. A payment processing application may be configured to inform the POS terminal that the donee credentials are linked to donor credentials. Processing the second transaction may include issuing and/or receiving an authorization decision granting the second transaction based on available credit or funds associated with the donor credentials. The authorization decision may be transmitted to the POS terminal by the issuer computer system.

Methods may include validating entry of a passcode. The passcode may be defined by the donor. The passcode may be defined by the donee. Requiring entry of a donor defined passcode may ensure that a user of the donee payment instrument is the donor's intended beneficiary.

The POS terminal may be configured to prompt for the passcode. A payment processing application, executed by the microchip or POS terminal, may configure the POS terminal to prompt for the passcode. In some embodiments, an issuer computer system may configure the POS terminal to prompt for the passcode in response to detecting that donee credentials are linked to donor credentials.

The payment processing application may configure the POS terminal to prompt for the passcode before processing the second transaction using donor credentials. The payment processing application may be configured to prompt for the passcode before transmitting donor credentials to the POS terminal. The POS terminal may be configured to prompt for the passcode before processing the second transaction using the donor credentials.

After linking the donor credentials to the donee payment instrument, the payment processing application on the donee payment instrument configure a POS terminal to formulate an authorization request for the second transaction that includes the donor credentials. The authorization request may be transmitted to an issuer computer system. The issuer computer system may provide a response (e.g., “granted” or “denied”) to the authorization request.

Methods may include receiving, from the donor, restrictions associated with use of the donor credentials. The restrictions may be applied to the second transaction. The restrictions may be applied each time a transaction is initiated using the donee payment instrument to access the linked donor credentials.

Methods may include storing the restrictions on the payment instrument. The restrictions may be encrypted. A payment processing application, when executed, may apply the restrictions to a transaction. In some embodiments, the POS terminal may apply the restrictions to a transaction. In some embodiments, an issuer computer system may apply the restrictions to a transaction.

Donor credentials may include a donor checking account. After the initiating and before completing execution of the second transaction, methods may include determining whether an amount of funds in the donor checking account is greater than or equal to an amount of credit required for the processing of the second transaction. Methods may include aborting the second transaction when the amount of funds in the donor checking account is less than the amount of credit required for the processing of the second transaction.

Methods may include initiating a third transaction using donee credentials. Methods may include requiring confirmation from the donor before processing the third transaction using donor credentials linked to the donee credentials. For example, the third transaction may be initiated by a donee at a location outside borders associated with geographic restrictions defined by the donor. Methods may allow the donor to confirm use of the donor credentials for the transaction and override the restrictions.

Methods may include receiving a request for assistance from the donee. The request may include a reason why the donee needs assistance. Before linking donee credentials to the donor credentials, methods may include using an artificial intelligence algorithm to verify the reason provided by the donee. Based on the verifying, methods may include linking donor credentials to the donee credentials.

The artificial intelligence (“Al”) algorithm may include obtaining permission from the donee to access at least two data sets created by the donee. A data set may include information shared by the donee on one or more social media platforms. A data set may include financial data such as transaction histories or account balances.

The AI algorithm may identify a subset of information included in the data sets. A subset may be based on information associated with a time stamp within a time window. A subset may be based on information associated with a location stamp within a geographic area. The time window or geographic area may be determined by a donor or by the AI algorithm.

The AI algorithm may formulate a plurality of queries for verifying the reason provided by the donee. The AI algorithm may formulate the queries based on meanings derived from the data sets and subsets. For example, the AI algorithm may confirm career changes or life challenges. The AI algorithm may confirm lifestyle changes or other contextual clues that support a donee's request for assistance. Exemplary lifestyle changes may include moving to reduce housing costs or looking for a new job. Contextual clues may include comments or posted pictures that indicate a change in spending habits or use of charitable services.

The AI algorithm may run the queries against the at least two data sets. The AI algorithm may run the queries against subsets of data included in the at least two data sets.

Formulating the plurality of queries may be based on queries generated for multiple data sets associated with multiple donees. For example, the AI algorithm may formulate verification queries for multiple donees. Machine learning may determine information within a data set that is particularly relevant to verifying a reason provided by a donee. Formulating the plurality of queries may be based on verifying multiple reasons provided by the multiple donees that triggered successful linking to a set of donor credentials.

Donee credentials may be linked to two or more sets of donor credentials. Each set of donor credentials may require a different level of verification. A level of verification may be set by a donor. A level of verification may be system set based on attributes of the donor credentials. Illustrative attributes may include transaction history of associated with the donor credentials. The AI algorithm may learn to automatically apply a threshold level of verification to a new donee request based on previously identified donor data sets. The AI algorithm may learn to identify, for a given donee request, data sets that include relevant information for providing a threshold level of verification.

When the queries formulated by the AI algorithm return a threshold level of corroboration of the donee reason, methods may include configuring a biometric feature of the donee as a passcode for processing a transaction using the donor credentials. Methods may include processing the second transaction using the donor credentials in response to receiving and validating the biometric feature.

Apparatus for a payment instrument is provided. Illustrative payment instruments may conform to specifications published by the International Organization for Standardization. Illustrative specifications may include: ISO/IEC 7810, ISO/IEC 7811 and ISO/IEC 7816, which are hereby incorporated herein by reference in their entireties. Suitable purchasing instruments may include a credit card, debit card, electronic purchasing devices and mobile devices.

A payment instrument may be associated with a digital wallet application. The digital wallet application may run on a mobile device. The digital wallet application may be configured to communicate with a merchant point-of-sale (“POS”) terminal. The digital wallet application may transfer a token or other credentials to the POS terminal.

Illustrative credentials may include:
Brand (i.e., issuer, transaction network, acquirer)
Customer name
Expiration date
Payment instrument security code (“CSC”)
Payment instrument verification data (“CVD”)
Payment instrument verification value (“CVV,” “CVV2,” “iCVV” or “Dynamic CVV”)
Payment instrument verification value code (“CWC”)
Payment instrument verification code (“CVC” or “CVC2”)
Verification code (“V-code”)
Payment instrument code verification (“CCV”)
Signature panel code (“SPC”)
Customer identification number (“CID”)
Payment instrument account number
Affinity Product (i.e., rewards card, platinum card, signature card, etc.)

Based on credentials received from the digital wallet, the POS terminal may attempt to process a purchase transaction. Processing the purchase transaction may include formulating an authorization request. Processing the transaction may include determining whether donee credentials are linked to donor credentials. Processing the transaction may include determining whether the transaction qualifies for using donor credentials. Processing the transaction may include determining whether the transaction complies with donor restrictions.

A payment instrument may include a housing. The housing may be any suitable size. For example, the housing may be 85.60 millimeters (“mm”)×53.98 mm×0.8 mm. This form factor may allow a payment instrument to fit easily into a wallet, pocket and card reader.

A payment instrument may include a microchip. The microchip may implement “EMV” compliant protocols. EMV is a technology that derives its name from the companies (Europay, MasterCard, and Visa) that developed the technology. The microchip may be configured to receive power from the POS terminal. In response to receiving the power, the microchip may execute a payment processing application.

The payment processing application may be a computer program. The payment processing application may orchestrate processing of a transaction. The transaction may be a purchase of a product. The payment processing application may be executed by the microchip. The payment processing application may be executed by a POS terminal. The payment processing application may provide credentials needed to process a transaction.

The payment processing application may implement a security layer before providing credentials. For example, the payment processing application may require entry of a passcode at a POS terminal before providing credentials to the POS terminal.

A microchip may include two or more payment processing applications. One payment processing application may provide donee credentials. Another payment processing application may provide donor credentials.

A payment processing application may include computer executable instructions that, based on donee credentials stored on the microchip, locate donor credentials linked to the donee credentials. The computer executable instructions may configure a POS terminal to require a passcode associated with the donor credentials. The passcode may be defined by a donor. The donor may provide the passcode to a donee authorized to utilize donor credentials.

In response to receiving the passcode, the computer executable instructions may further configure the POS terminal to execute a first transaction that uses the donor credentials to associate funds with the donee credentials. The first transaction may transfer funds from a donor account to a donee account. The amount transferred from the donor account may correspond to an amount of a product scanned by the POS terminal.

The first transaction may transfer funds from a donor account to a specially created account. The donee may have access to the specially created account. The first transaction may place a hold on funds in a donor account. Based on the hold, a line-of-credit may be extended to the donee. The line-of-credit may be linked to the donee credentials.

After completing the first transaction, the computer executable instructions may execute a second transaction. The second transaction may use donee credentials to purchase the product. The donee credentials may include a donee account. The first transaction may associate the donee account with funds/credit, provided based on donor credentials, to complete the purchase.

The payment instrument may include a wireless circuit. The microchip may be activated in response the wireless circuit receiving a wireless signal from the POS terminal. The wireless signals may be high frequency signals. High frequency signals may be signals that have a transmission range that is less than 50 centimeters (“cm”).

A payment instrument may include a first payment processing application. The payment instrument may include a second payment processing application. In response to receiving power from the POS terminal, the microchip may execute the second payment processing application for purchasing a product. The second payment processing application may only execute a transaction using donee credentials (e.g., the second transaction) to purchase the product using donor supplied funds or credit.

The microchip may be configured to execute the second payment processing application based on an identity or cost of the product being purchased. The microchip may be configured to execute the second payment processing application based on a location of the POS terminal. The microchip may be configured to execute the second payment processing application based on identity of a merchant that operates the POS terminal.

For a first amount, a payment processing application may be configured to execute the second transaction without the first transaction. For a second amount, a payment processing application may be configured to execute the first and second transactions.

For example, restrictions associated with using donor funds or credit, may include a maximum limit on how much of donor funds may be used in a single purchase. If the donee attempts a purchase for an amount above the maximum, the payment processing application may be configured to use donor funds/credit for the amount up to the maximum. The payment processing application may use donee funds/credit for the remaining amount of the purchase. Donor funds/credit may be accessed using donor credentials linked to the donee credentials. Donee funds/credits may be accessing using donee credentials.

As a further example, donor restrictions may limit use of donor funds/credit to specific products. A purchase may include the specific product and other products. The payment processing application may be configured to use donor funds/credit for the specific product and donee funds/credit for the other products.

A payment processing application may configure the POS terminal to send an alert to a donor each time the donor's credentials or funds/credit are used.

Apparatus for a payment instrument is provided. The payment instrument may include a housing. The housing may be plastic, metal or any suitable material. The payment instrument may include a microchip. The microchip may be embedded in the housing. A payment processing application may be stored on the microchip. The payment processing application may be configured to extract location information based on communication with a POS terminal.

The payment processing application may determine that the payment instrument is at a first location. At the first location, the payment processing application may interact with the POS terminal as a donor payment instrument. Interacting with the POS terminal as a donor payment instrument may include paying for a purchase using donor credentials to access donor funds/credit.

At a second location, the payment processing application may be configured to interact with the POS terminal as a donee payment instrument to pay for the purchase. Interacting with the POS terminal as a donee payment instrument may include paying for a purchase using donee credentials to access donee funds/credit. The first location may be within a threshold distance of an address associated with the payment instrument. The second location may be outside the threshold distance associated with the first location.

The payment processing application may be configured to determine an identity of an operator of a POS terminal requesting donor or donee credentials. When the operator is a target operator, the payment processing application may interact with the POS terminal as a donor payment instrument. Donor credentials may be stored on the microchip as an encrypted token.

The payment processing application may be configured to generate an alert. The payment processing application may generate the alert in response to interacting with the POS terminal as the donor payment instrument. The payment processing application may configure the POS terminal to transmit the alert to a donor associated with donor credentials used for a transaction. To transmit the alert, the payment processing application access a communication network via the POS terminal.

The payment processing application may be further configured to receive a denial authorization decision from an issuer computer system. The denial may be associated with a purchase at the second location.

In some embodiments, the payment processing application may determine that a purchase at the second location includes a target product. The target product may be a product that a donor has authorized purchasing using donor credentials. At the second location, the payment processing application may interact with the POS terminal as the donor payment instrument and pay for only the target product. The payment processing application may not attempt to pay for any other products using donor credentials.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown and/or described herein. Method embodiments may omit steps shown and/or described in connection with illustrative methods. Method embodiments may include steps that are neither shown nor described in connection with illustrative methods. Illustrative method steps may be combined. For example, an illustrative method may include steps shown in connection with any other illustrative method.

Apparatus may omit features shown and/or described in connection with illustrative apparatus. Apparatus embodiments may include features that are neither shown nor described in connection with illustrative apparatus. Features of illustrative apparatus may be combined. For example, an illustrative apparatus embodiment may include features shown or described in connection with another illustrative apparatus/method embodiment.

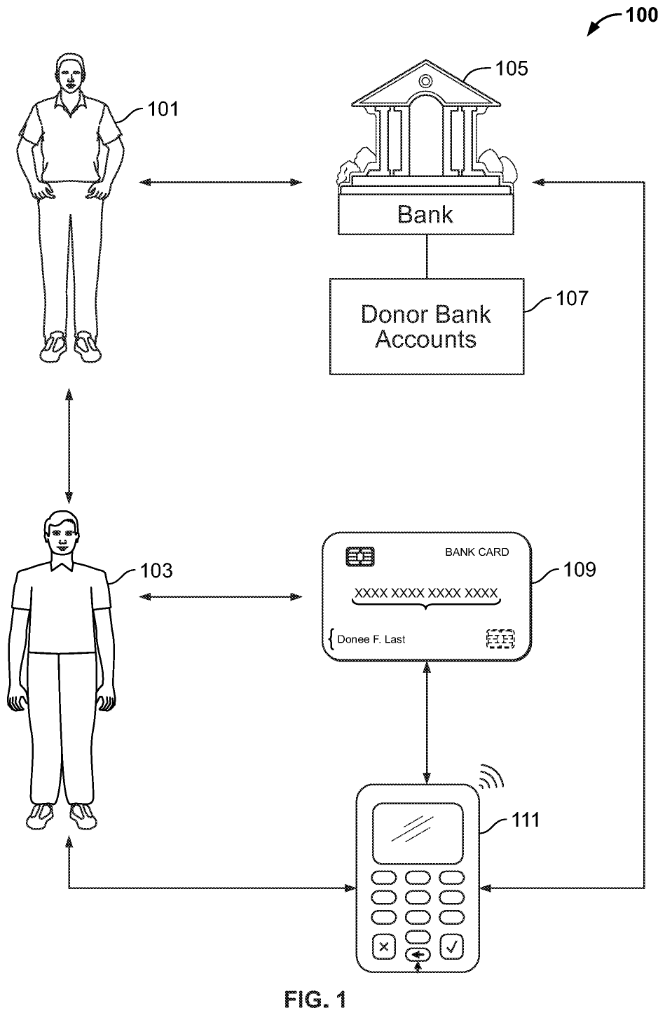

FIG. 1 shows illustrative scenario 100. Scenario 100 shows that donor 101 is associated with donor bank 105. Donor bank 105 may issue donor credentials to donor 101. Donor credentials may provide access to donor funds/credit. For example, donor credentials may include donor bank accounts 107.

Scenario 100 shows donee 103. Donee 103 is associated with payment instrument 109. Donee 103 may be associated with a donee bank (not shown). The donor bank 105 may be the donee bank. The donee bank may issue donee credentials to donee 103. Donee credentials may provide access to donee funds/credit. Payment instrument 109 may include the donee credentials. Payment instrument 109 may include a payment processing application that provides donee credentials to POS terminal 111.

Scenario 100 shows that donee 103 may use payment instrument 109 to pay for a purchase at POS terminal 111. In response to receiving donee credentials from payment instrument 109, POS terminal may initiate communication with donor bank 105. Donor bank 105 may authorize the purchase based on funds available in donor bank accounts 107.

In some embodiments, the payment processing application may link donee credentials to donor credentials. In some embodiments, the donee bank may link the donee credentials to the donor credentials.

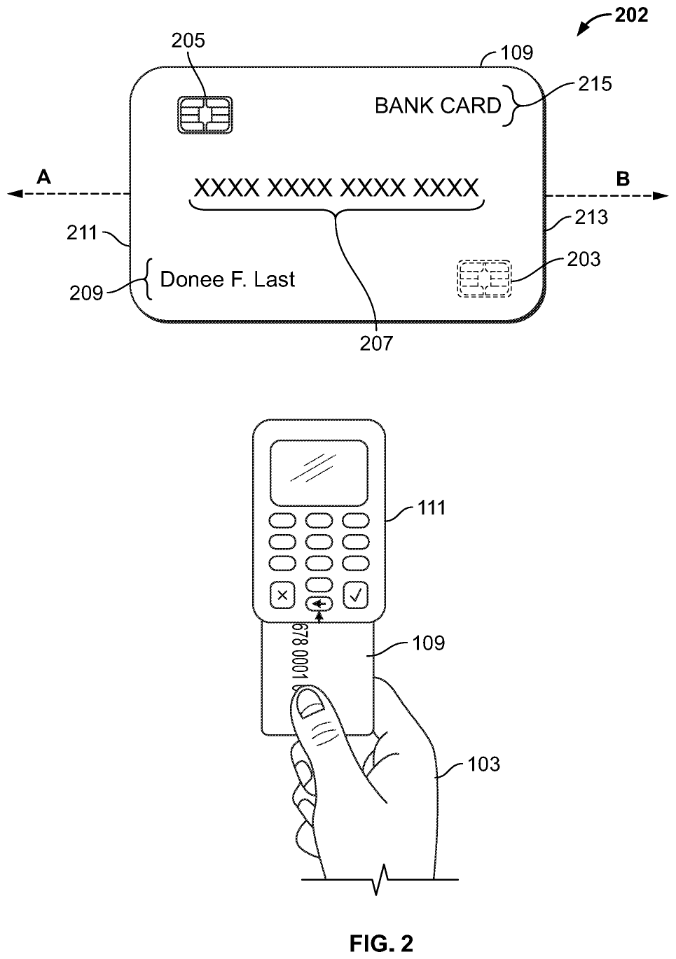

FIG. 2 shows payment instrument 109. Payment instrument 109 includes microchip 205. Payment instrument 109 includes informational items 215 (issuer), 207 (card number) and 209 (customer name). Microchip 205 is positioned relative to informational items 215, 207 and 209. The location of microchip 205 may be an industry-standard location defined by the International Organization for Standardization (“ISO”) and the International Electrotechnical Commission (“IEC”). Exemplary standards for the location of microchip 205 include ISO/IEC 7816 and/or ISO/IEC 14443.

Microchip 205 may be positioned such that when leading edge 211 of payment instrument 109 is inserted into POS terminal 111 in direction A, microchip 205 will be positioned to be readable by POS terminal 111. When leading edge 211 of payment instrument 109 is inserted into POS terminal 111 in direction A, microchip 205 may be positioned, inside POS terminal 111, in an industry-standard location.

Payment instrument 109 also includes microchip 203. Microchip 203 may be positioned such that when leading edge 213 of payment instrument 109 is inserted into POS terminal 111 in direction B, microchip 203 will be read by POS terminal 111. When leading edge 213 of payment instrument 109 is inserted into POS terminal 111 in direction B, microchip 203 may be positioned, inside POS terminal, in an industry-standard location.

Microchip 203 is shown in broken line. Some embodiments may not include microchip 203. In such embodiments, donee and donor credentials may both be stored on microchip 205. Microchip 205 may include two payment processing applications. A first payment processing application may be used to provide donee credentials to POS terminal 111. A second payment processing application may be used to provide donor credentials to POS terminal 111. In some embodiments, a single payment processing application may be used to provide both donee and donor credentials to POS terminal 111.

In some embodiments, microchip 203 may be embedded within a thickness of a housing of payment instrument 109 and may not be visible from an outside of payment instrument 109. Embedding microchip 203 within the thickness of payment instrument 109 may hide an existence of microchip 203 from others besides a donee user of payment instrument 109. Microchip 203 may include a wireless circuit for communicating with a POS terminal.

In some embodiments, microchip 203 may be covered by a housing of payment instrument 109 such that microchip 203 is not visible from an outside of payment instrument 109 and is readable via contact-based communication with a POS terminal. For example, a technique for producing conductive polymer material is now available. Such techniques are described an article entitled “A nonconjugated radical polymer glass with high electrical conductivity” and available at http://science.sciencemag.org/content/359/6382/1391?utm_campaign=toc_sci-mag_2018-03-22&et_rid=40174079&et_cid=1923453, and is hereby incorporated by reference herein in its entirety.

Microchip 203 may be covered with a conducting polymer film. The conducting polymer film may hide a presence of microchip 203 when viewing an outside of payment instrument 109. However, when payment instrument 109 is inserted into POS terminal 111 in direction B, microchip 203 may be read by electrical contacts of POS terminal 111 through the conducting polymer film.

Covering microchip 203 with an opaque film may secure credentials stored on microchip 203. Even if payment instrument 109 were to fall into the hands of an unauthorized user, the unauthorized user would not be aware of the presence of microchip 203, and would not consider inserting leading edge 213 into a card reader in direction B.

In some embodiments, microchip 205 may store donee credentials. Donor 101 may authorize donee 103 to use donor credentials. Donor credentials may be linked to the donee credentials. Based on such authorization and link, when donee 103 inserts payment instrument 109 into POS terminal in direction A, POS terminal may prompt donee 103 to pull payment instrument 109 out of POS terminal reinsert payment instrument 109 in direction B. Inserting payment instrument 109 into POS terminal 111 in direction B may position microchip 203 to read and receive information from POS terminal 111.

POS terminal 111 may add donor credentials to microchip 203. Donor credentials may be added based on detecting that a donor has authorized the donee associated with the donee credentials to use the donor credentials. The authorization of the donee may be detected by an issuer of the donee payment instrument.

In some embodiments, donor credentials added to microchip 203 may be credentials for accessing a specially created account. The specially created account may hold funds or credit provides by one or more donors.

After donor credentials are added to microchip 203, payment instrument 109 may inserted into POS terminal 111 in direction B to execute a transaction using the donor credentials.

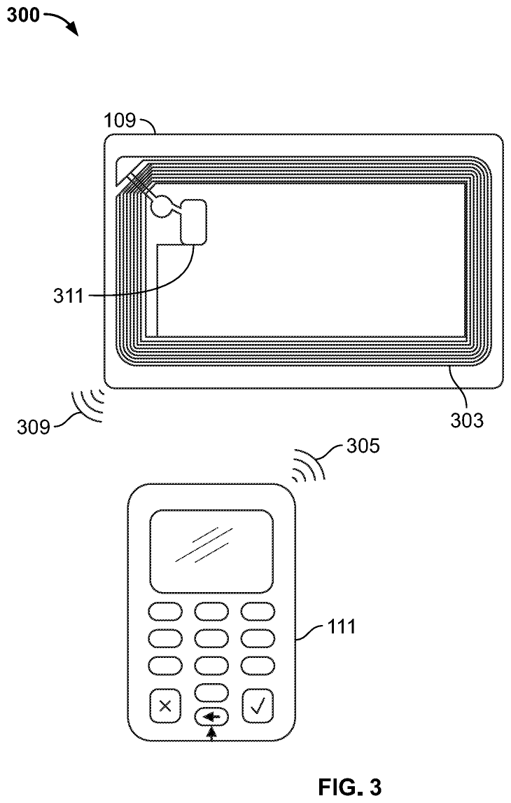

FIG. 3 shows that payment instrument 109 may include wireless circuit 303. Wireless circuit 303 may provide Wi-Fi, near-field communication (“NFC”), Bluetooth, satellite, cellular or any other suitable mode of wireless communication. Wi-Fi may include passive Wi-Fi with lower power consumption than typical Wi-Fi. The communication circuit may have a thickness that is not greater than 0.8 mm. Using wireless circuit 303 payment instrument 109 may communicate wirelessly with POS terminal 111.

Payment instrument 109 includes processor circuit 311. Processor circuit 311 may alternatively be referred to herein as a software chip. Processor circuit 311 may have a thickness that is not greater than 0.25 mm. Processor circuit 311 may include a microprocessor for controlling operation of payment instrument 109 and its associated components. Processor circuit 311 may control operation of microchips 205 and/or 203. In some embodiments, microchip 205 and/or 203 may include processor circuit 311.

Processor circuit 311 may include RAM, ROM, an input/output (“I/O”) module and a non-transitory or non-volatile memory. The I/O module may include a microphone, button and/or touch screen which may accept user provided input. The I/O module may include one or more of a speaker for providing audio output and a video display for providing textual, audiovisual and/or graphical output. The video display may include one or more organic light emitting diodes.

Software may be stored within the non-transitory memory and/or other storage medium. The software may provide instructions to processor circuit 311 for enabling payment instrument 109 to perform various functions. For example, the non-transitory memory may store software used by payment instrument 109 such as an operating system, application programs, and an associated database.

Application programs, which may be used by payment instrument 109, may include computer executable instructions for invoking user functionality related to communication, such as email, short message service (“SMS”), and voice input and speech recognition applications. Application programs may utilize one or more algorithms that control prompts presented at a merchant POS terminal, process received executable instructions, perform power management routines or other suitable tasks.

Processor circuit 311 may store information needed to execute a purchase transaction. Processor circuit 311 may include a payment processing application. Processor circuit 311 may include a payment processor application that is different from a payment processing application stored on microchips 205 and/or 203.

Processor circuit 311 may store series of randomly generated numbers (e.g., a “token”) that correspond to a set of credentials. The token may be transmitted from payment instrument 109 to POS terminal 111. The POS terminal may forward the token to an issuer associated with payment instrument 109. The issuer may hold a key needed to decipher the token and correlate the token to a specific account. The issuer may provide the POS terminal with an authorization decision that approves or denies the purchase transaction. The token may be dynamically changed with each transaction so that a token is only usable for a single transaction.

Processor circuit 311 may control communications 305 and 309 between wireless circuit 303 and POS terminal 111. When payment instrument 109 is within a communication range of POS terminal 111, processor circuit 311 may receive power from POS terminal 111. POS terminal 111 may emit high frequency signals that provide power to microchips 205, 203 and/or processor circuit 311.

Processor circuit 311 may issue commands to POS terminal 111. The commands may reconfigure payment instrument 109 such that donor credentials are linked to payment instrument 109. For example, commands issued by processor circuit 311 may configure POS terminal 111 to add donor credentials to microchip 203. In some embodiments, commands issued by processor circuit 311 may configure POS terminal 111 to add donor credentials to microchip 205.

When donee 103 successfully provides authentication for processing a transaction using donor credentials, POS terminal 111 may submit an authorization request to an issuer using the donor credentials stored on microchips 203 and/or 205. As part of an authorization decision process, the issuer may evaluate whether to approve a purchase transaction based on the donor credentials.

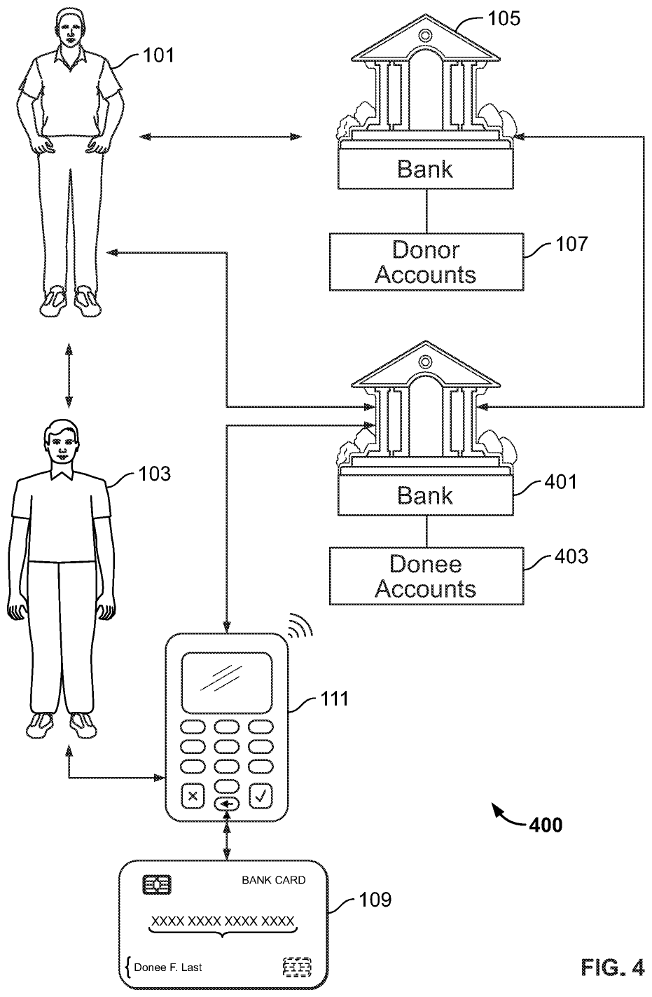

FIG. 4 shows illustrative apparatus and scenario 400. Scenario 400 includes donor 101. Donor 101 is associated with donor bank 105. Donor bank 105 may administer donor accounts 107. Scenario 400 includes donee 103. Donee 103 may be associated with donee bank 401. Donee bank 401 may administer donee accounts 403. Donor 101 may authorize donee 103 to utilize donor credentials. Utilizing donor credentials may include accessing funds stored in donor accounts 107.

Scenario 400 shows that donee 103 may initiate a transaction, such as a purchase using payment instrument 109. Payment instrument 109 may communicate with POS terminal 111. Payment instrument 109 may communicate donee credentials to POS terminal 111. POS terminal 111 may submit the donee credentials to donee bank 401. Donee bank 401 may be an issuer that provides authorization decisions for transactions initiated using payment instrument 109.

Donee bank 401 may communicate with donor bank 105. In some embodiments, donee bank 401 and donor bank 105 may be the same bank. In some embodiments, donor bank may receive an authorization from a donor to grant donee 103 access to donor accounts 107. Donee bank 401 may receive donee credentials from payment instrument 109 (via POS terminal 111) and communicate with donor bank 401. Donee bank 401 may issue an authorization decision to POS terminal 111 based on information received from donor bank 105 regarding donor accounts 107. Donee bank 401 may grant a transaction based on funds available in donor accounts 107. The transaction may have otherwise been denied based on donee accounts 403.

In some embodiments, donor 101 may authorize a transfer of funds/credit from donor accounts 107 to donee accounts 403. The transfer of funds/credits may be initiated in response to POS terminal 111 submitting donee credentials to donee bank 401 to pay for a purchase. When donor 101 authorizes a transfer of funds/credit from donor accounts 107 to donee accounts 403, an identity of donor bank 105 may be stored on payment instrument 109. In some embodiments, an identity of donor bank 105 may be linked to donee accounts 403 by donee bank 401. Before payment instrument 109 communicates with POS terminal 111, donor bank 105 may communicate the authorization of donor 101 to donee bank 401. Donee bank 401 may add the identity of donor bank 107 when payment instrument 109 is inserted into POS terminal 111.

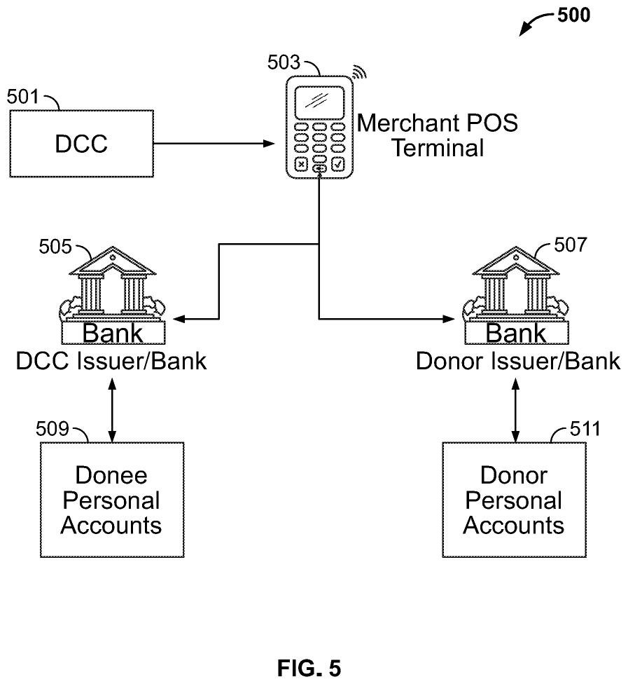

FIG. 5 shows illustrative apparatus and scenario 500. Scenario 500 shows that a donee may present donee credit card (“DCC”) 501 to POS terminal 503. The donee may present DCC 501 to pay for a purchase of goods or services from a merchant. A payment processing application on DCC 501 may configure POS terminal 503 to perform two steps to process payment for the purchase.

A first step may include the payment processing application providing donee credentials to POS terminal 503. The donee credentials are routed to bank 505. Bank 505 may be an issuer associated with DCC 501. Bank 505 may issue an authorization decision for a first amount of the purchase amount. Bank 505 may issue the authorization decision based on a balance and transaction history associated with donee personal accounts 509. Bank 505 may deny the first amount. Bank 505 may grant the first amount.

A second step may include the payment processing application providing donor credentials that are routed to bank 507. Bank 507 may be associated with donor personal accounts 511. Bank 507 may issue an authorization decision for a second amount of the purchase amount. Bank 507 may issue the authorization decision based on a balance and transaction history associated with donor personal accounts 511. Bank 507 may deny the second amount. Bank 507 may grant the second amount. Bank 507 may grant the first and second amounts.

In some embodiments, providing donor credentials may trigger a debit to donor personal accounts 511. In some embodiments, providing donor credentials may draw down a line-of-credit associated with donor personal accounts 511.

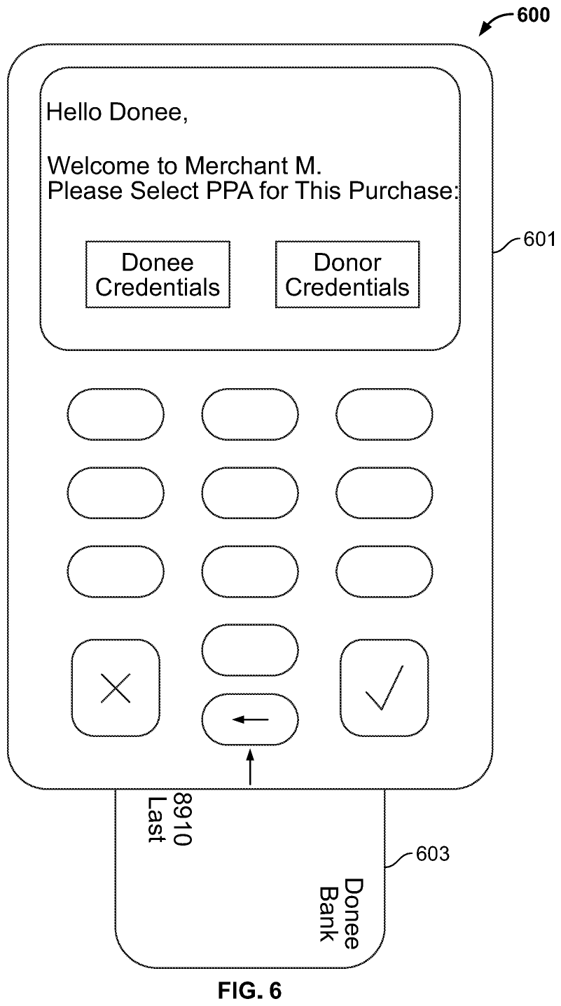

FIG. 6 shows illustrative apparatus and scenario 600. Scenario 600 shows that a microchip on a payment instrument may include two payment processing applications. In scenario 600, a microchip of payment instrument 603 is positioned within POS terminal 601. In some embodiments, POS terminal 601 may be configured to detect that there are two (or more) payment processing applications on the microchip. In some embodiments, microchip, when powered by POS terminal 601 may configure POS terminal 601 to prompt a donee to select a desired payment processing application (“PPA”).

Scenario 600 shows that payment instrument 603 includes a first PPA for processing a transaction using donee credentials. Scenario 600 also shows that payment instrument 603 includes a second PPA for processing the transaction using donor credentials. In some embodiments, code on the microchip may verify whether a purchase complies with restrictions associated with donor credentials. If the purchase complies with the restrictions, then POS terminal 601 may be configured to prompt the donee to choose whether to apply donor or donee credentials. If the purchase does not comply with the restrictions, donee credentials may be applied and the POS terminal 601 may not present an option for providing donor credentials.

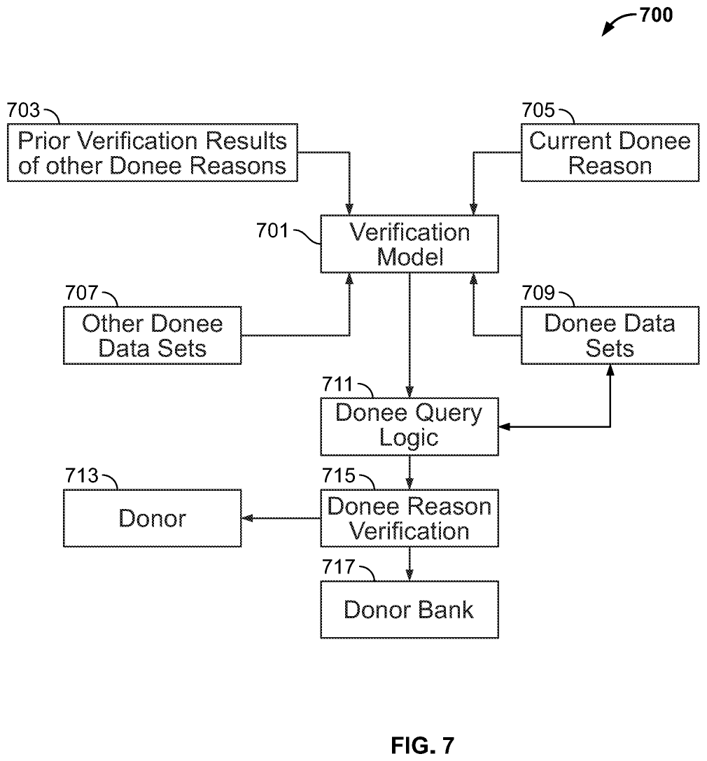

FIG. 7 shows illustrative artificial intelligence (“Al”) algorithm 700. AI algorithm may verify a reason for assistance provided by a donee.

AI algorithm 700 includes verification model 701 that receives various inputs. Verification model 701 receives current donee reason 705. For example, current donee reason 705 may be that donee is out of job or is suffering from a health ailment. Verification model 701 receives donee data sets 709. Donee data sets 709 include information that will be utilized by verification model 701 to verify current donee reason 705. Illustrative data sets may include social media posts and bank account transaction histories.

Verification model 701 receives other donee data sets 707. Donee data sets 707 include information utilized by verification model 701 to verify reasons provided by other donees. Verification model 701 receives prior verification results 703. Prior verification results 703 may include logic applied to other donee data sets 707 to verify reasons for assistance provided by the other donees. Prior verification results 703 may include specific informational items identified within other donee data sets that were used to verify reasons for assistance provided by the other donees.

For example, a donee reason may be that the donee is looking for a job. The AI algorithm may attempt to identify information within the social media information that is relevant to verifying the reason provided by the donee. Relevant information may include where the donee has been, where the donee is living, comments posted by the donee, where the donee is shopping and what the donee is buying while looking for a job. Identifying relevant information may include picture analysis to determine what the donee was doing while looking for a job.

Verification model 701 may provide outputs. The outputs may be determined based on the inputs. Verification model 701 outputs donee query logic 711. Donee query logic 711 includes logical questions that will be applied to donee data sets 709. Donee query logic 711 may identify informational items within donee data sets 709 likely to contain relevant information for verifying current donee reason 705. Donee query logic 711 may evaluate whether the identified relevant informational items support or detract from current donee reason 705.

Applying donee query logic 711 to donee data sets 709 provides donee reason verification 715. Donee reason verification 715 may include a verification score. A verification score above a first threshold may indicate that donee data sets 709 support current donee reason 705. A verification score below the first threshold may indicate that donee data sets 709 do not support current donee reason 705. A verification score below a second threshold may indicate that donee data sets 709 undermine current donee reason 705.

Donee reason verification 715 may be provided to donor 713. Based on donee reason verification 715, donor 713 may decide whether to provide a donee access to donor credentials. Based on donee reason verification 715, donor 713 may apply restrictions that are applied when a donee accesses donor credentials.

Donee reason verification 715 is also provided to donor bank 717. In some embodiments, if the verification score is below a threshold score, donor bank 717 may suspend donee access to donor credentials.

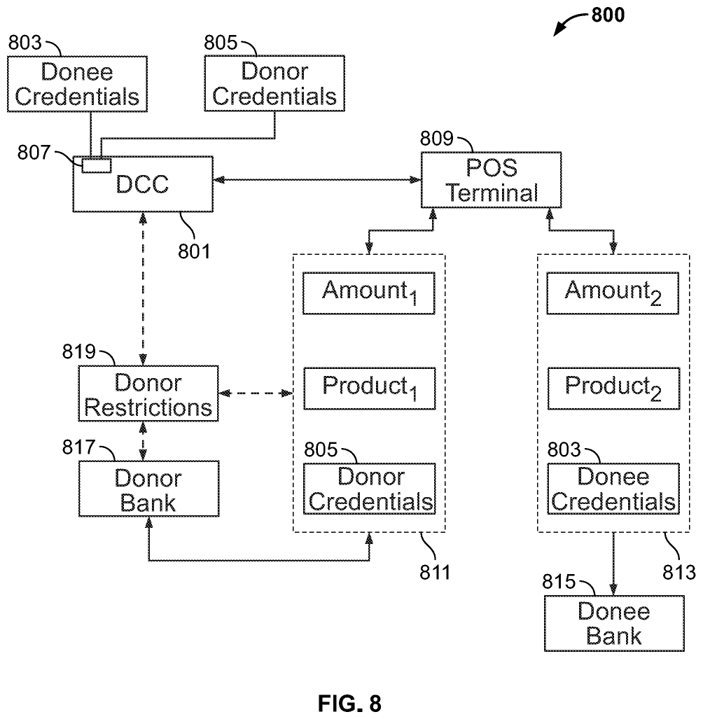

FIG. 8 shows illustrative scenario 800. In scenario 800, a donee presents donee credit card (“DCC”) 801 to POS terminal 809. DCC 801 includes microchip 807. Microchip 807 includes donee credentials 803. Microchip 807 also includes donor credentials 805. DCC 801 may be presented to POS terminal 809 to pay for purchase 811 and/or purchase 813.

Donor credentials 805 may be a series of randomly generated numbers (“token”). The token may be transmitted to POS terminal 809 by a payment processing application (also stored on microchip 807) to pay for purchase 811. POS terminal 809 may forward the token to donor bank 817. Donor bank 817 may hold a key needed to decipher the token and correlate the token to a donor bank account.

As part of an authorization process, donor bank 817 may examine the donor bank account and/or a historical transaction history associated with the donor bank account. As part of an authorization process, donor bank 817 may determine whether purchase 811 complies with restrictions 819. Donor bank 817 may provide POS terminal 809 with an authorization decision that either grants or denies purchase 811.

Donor bank 817 may provide POS terminal 809 an updated token that is uploaded to microchip 807 by POS terminal 809. A token stored on microchip 807 may be dynamically changed with each transaction so that a token is only usable for a single transaction.

Donee credentials 803 may also be a token. The token may be transmitted to POS terminal 809 by a payment processing application to pay for purchase 813. POS terminal 809 may forward the token to donee bank 815. Donee bank 815 may hold a key needed to decipher the token and correlate the token to a donee bank account.

As part of an authorization process, donee bank 815 may examine the donor bank account and/or a historical transaction history associated with the donor bank account. Donee bank 815 may provide POS terminal 809 with an authorization decision that either grants or denies purchase 813.

In some embodiments, purchases 811 and 813 may be part of a single large purchase. Based on applying restrictions 819, Product₁ and/or Amount₁ of purchase 811 may be deemed eligible for using donor credentials 805. Based on applying restrictions 819, Product₂ and/or Amount₂ of purchase 813 may be deemed ineligible for using donor credentials 805. Because purchase 813 is ineligible for using donor credentials 805, purchase 813 may be processing using donee credentials 803. Purchase 811 may be granted by donor bank 817 and purchase 813 may be denied by donee bank 815. Purchase 811 may be denied by donor bank 817 and purchase 813 may be granted by donee bank 815.

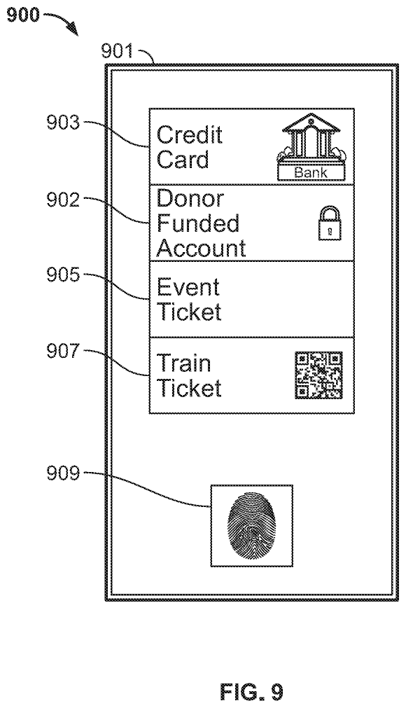

FIG. 9 shows illustrative operational screenshot 900 on mobile device 901. Mobile device 901 may be a used a payment instrument by a donee. Screenshot 900 shows a digital wallet application running on mobile device 901. The digital wallet application includes virtual credit card 903. Virtual credit card 903 may correspond to a donee credit card. The digital wallet application includes virtual event ticket 905 and virtual train ticket 907.

The digital wallet application also includes donor funded account 902. Donor funded account 902 may be added to the digital wallet application in response to receiving and verifying a donee request for assistance. Donor funded account 902 may require validation of biometric feature 909 to access funds/credit associated with donor funded account 902. A donor may specify any suitable authentication method for accessing Donor funded account 902.

In some embodiments, one or more donors may create a special account and add funds/credit to the specially created account. Donor funded account 902 may be added as a payment option within a donee's digital wallet application to provide access to funds in the specially created account. In some embodiments, donor funded account 902 may be a link to donor credentials. The donor credentials may provide direct access to funds or credit in a donor account.

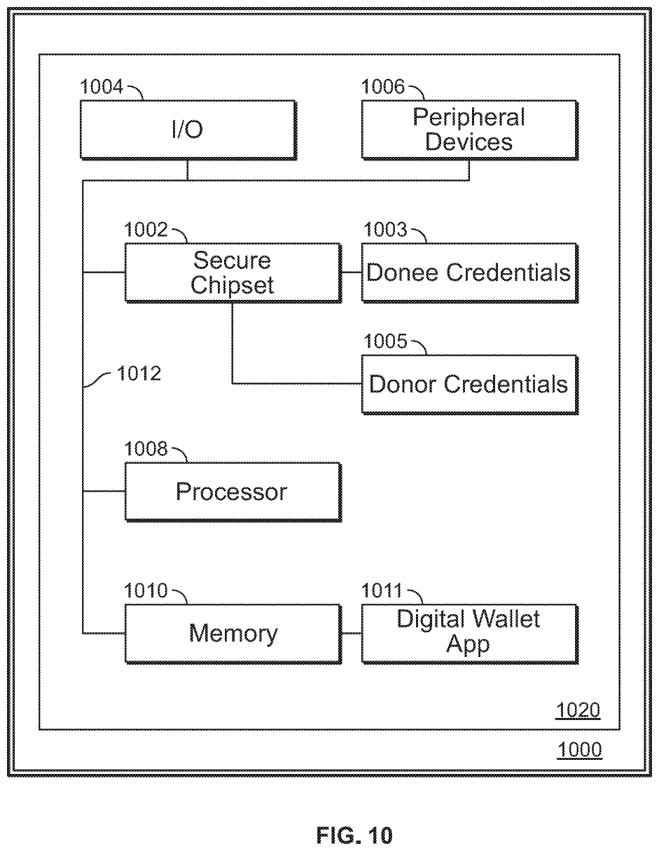

FIG. 10 shows illustrative hardware and digital information components 1000 that may be included in payment instruments disclosed herein. Such payment instruments include payment instrument 109, payment instrument 501, payment instrument 603, payment instrument 807 and mobile device 901. Components 1000 may include one or more integrated circuits which may be configured to perform any suitable logical operation.

Components 1000 include secure chipset 1002. Secure chipset 1002 may be a microchip described herein. Secure chipset 1002 may be an isolated chip on a mobile device that has limited interaction with the rest of the mobile device's operating system.

For example, secure chipset 1002 may be “isolated” because it is only accessible when the mobile device is within communication range of a merchant POS terminal. Secure chipset 1002 may only be accessed by the merchant POS terminal and not by the operating system running on the mobile device.

Secure chipset 1002 stores donor credentials 1005. Secure chipset 1002 stores donee credentials 1003. Secure chipset 1002 may also store one or more payment processing applications for providing donor credentials 1005 and donee credentials 1003 to a POS terminal.

Components 1000 include I/O circuitry 1004, which may include a transmitter device and a receiver device and may interface with fiber optic cable, coaxial cable, telephone lines, wireless devices, PHY layer hardware, a keypad/display control device or any other suitable encoded media or devices. I/O circuitry may include a near-field communication chip for wireless communication with a merchant POS terminal.

Hardware 1000 includes peripheral devices 1006, which may include counter timers, real-time timers, power-on reset generators or any other suitable peripheral devices. Hardware 1000 includes logical processing device 1008, which may compute data structural information, structural parameters of the data, run an AI algorithm.

Components 1000 include machine-readable memory 1010. Memory 1010 may store applications used by a mobile device, such as an operating system, application programs, web browser and a database. Applications may include digital wallet application 1011.

Components 1000 may be coupled together by a system bus or other interconnections 1012 and may be present on one or more circuit boards such as circuit board 1020. In some embodiments, the components may be integrated into a single chip. The chip may be silicon-based.

Thus, apparatus and methods for an EXTENDED PAYMENT INSTRUMENT are provided. Persons skilled in the art will appreciate that the present disclosure can be practiced by other than the described embodiments, which are presented for purposes of illustration rather than of limitation. The present disclosure is limited only by the claims that follow.

What is claimed is:

1. A payment instrument comprising:
a housing;
a microchip configured to receive power from a point-of-sale (“POS”) terminal and, in response to receiving the power, executes a payment processing application for purchasing a product that:
based on donee credentials stored on the microchip, locates donor credentials linked to the donee credentials;
configures the POS terminal to require a passcode associated with the donor credentials; and
in response to receiving the passcode, further configures the POS terminal to process:
a first transaction that uses the donor credentials to associate funds with the donee credentials; and then
a second transaction that uses the donee credentials to purchase the product using the associated donor funds.

2. The payment instrument of claim 1, the payment instrument further comprising a wireless circuit and the microchip is configured to be activated in response the wireless circuit receiving a wireless signal from the POS terminal.

3. The payment instrument of claim 1, wherein the payment processing application is a first payment processing application, and, in response to receiving the power, the microchip is configured to execute a second payment processing application for purchasing the product that only processes the second transaction to purchase the product.

4. The payment instrument of claim 1, the payment processing application is configured to:
for a first amount of the purchase, process the second transaction without the first transaction; and
for a second amount of the purchase, process the first and second transactions for a second amount.

5. The payment instrument of claim 1, wherein the payment processing application configures the POS terminal to send an alert to the donor each time the donor credentials are used to process the first transaction.

6. A payment instrument comprising:
a housing;
a microchip embedded in the housing; and
a payment processing application stored on the microchip and configured to:
extract location information from communication received from a point-of-sale (“POS”) terminal;
at a first location, interact with the POS terminal as a donor payment instrument to pay for a purchase; and
at a second location, interact with the POS terminal as a donee payment instrument to pay for the purchase.

7. The payment instrument of claim 6, wherein the first location is within a threshold distance of an address associated with the payment instrument.

8. The payment instrument of claim 6, wherein the payment processing application is configured to:
determine an identity of an operator of a POS terminal requesting the donor or donee credentials; and
when the operator is a target operator, at the second location, interact with the POS terminal as the donor payment instrument to pay for the purchase.

9. The payment instrument of claim 6 wherein the payment processing application is configured to:
generate an alert when interacting with the POS terminal as the donor payment instrument; and
configure the POS terminal to transmit the alert to a donor associated with the donor credentials.

10. The payment instrument of claim 6 wherein the payment processing application is further configured to:
receive a denial of a purchase at the second location;
determine that the purchase includes a target product; and
at the second location, interact with the POS terminal as the donor payment instrument to pay for the target product.

11. A method for using a donee payment instrument to process a transaction based on donor credentials, the method comprising:
receiving authorization from a donor to link the donor credentials to the donee payment instrument;
detecting use of the donee payment instrument at a point-of-sale (“POS”) terminal to initiate a first transaction using donee credentials;
using the POS terminal, reconfiguring the donee payment instrument such that the donor credentials are linked to the donee credentials; and
after reconfiguring the donee payment instrument, using the donee payment instrument to initiate a second transaction using the donee credentials and process the second transaction using the donor credentials.

12. The method of claim 11, further comprising validating entry of a passcode defined by the donor before processing the second transaction using the donor credentials.

13. The method of claim 11 further comprising, after the reconfiguring, when the donee payment instrument communicates with the POS terminal, the donee payment instrument configures the POS terminal to formulate an authorization request for the second transaction that includes the donor credentials.

14. The method of claim 11 further comprising:
receiving, from the donor, restrictions associated with use of the donor credentials;
storing the restrictions on the donee payment instrument; and
applying the restrictions to the second transaction.

15. The method of claim 11 wherein the donor credentials comprise a donor checking account and the method further comprising, after the initiating and before processing the second transaction:
determining whether an amount of funds in the donor checking account is greater than or equal to an amount of credit required for the processing of the second transaction; and
aborting the second transaction when the amount of funds in the donor checking account is less than the amount of credit required for the processing of the second transaction.

16. The method of claim 15 further comprising:
initiating a third transaction using the donee credentials; and
requiring confirmation from the donor before processing the third transaction using the donor credentials.

17. The method of claim 11 further comprising:
receiving a request for assistance from the donee, the request comprising a reason provided by the donee;
using an artificial intelligence algorithm, verifying the reason provided by the donee; and
based on the verifying, linking the donor credentials to the donee credentials.

18. The method of claim 17, wherein the artificial intelligence algorithm comprises:
obtaining permission from the donee to access at least two data sets created by the donee within a time window identified by the donor;
formulating a plurality of queries for verifying the reason;
running the queries against the at least two data sets; and
when the queries return a threshold level of corroboration of the reason:
configuring a biometric feature of the donee as a passcode for processing the second transaction using the donor credentials; and
processing the second transaction using the donor credentials in response to receiving the biometric feature;
wherein the formulating of the plurality of queries is based on queries generated for multiple data sets associated with multiple donees.

19. The method of claim 18, further comprising formulating the plurality of queries based on verifying multiple reasons provided by multiple donees for linking donee credentials of each donee to a different set of donor credentials.
